(19) United States
(12) Patent Application Publication
(10) Pub. No.: US 2015/0192750 A1
(43) Pub. Date: Jul. 9, 2015

(54) METHOD FOR MANUFACTURING CAMERA MODULE

(71) Applicant: Shinko Electric Industries Co., Ltd., Nagano-ken (JP)

(72) Inventor: Satoshi Shiraishi, Nagano-ken (JP)

(73) Assignee: Shinko Electric Industries Co., Ltd., Nagano-ken (JP)

(21) Appl. No.: 14/540,135

(22) Filed: Nov. 13, 2014

(30) Foreign Application Priority Data
Jan. 8, 2014 (JP) 2014-001679

(51) Int. Cl. G02B 7/00; G02B 7/02

(52) U.S. Cl. CPC G02B 7/003; G02B 7/02

(57) ABSTRACT

A method for manufacturing a camera module includes preparing an image capturing unit, preparing a lens unit, detecting the center of a light receiving surface of an image capturing element arranged in the image capturing unit, detecting the center of an opening of a diaphragm arranged in the lens unit, aligning the lens unit and the image capturing unit so that the center of the opening of the diaphragm coincides with the center of the light receiving surface of the image capturing element, and joining the lens unit and the image capturing unit after the aligning the lens unit and the image capturing unit.

### CROSS-REFERENCE TO RELATED APPLICATIONS

This application is based upon and claims the benefit of priority from prior Japanese Patent Application No. 2014-001679, filed on Jan. 8, 2014, the entire contents of which are incorporated herein by reference.

### FIELD

This disclosure relates to a method for manufacturing a camera module.

### BACKGROUND

The rapid progress and development of telecommunication technology has increased the speed and amount of data communication. As a result, mobile electronic devices, such as cell phones and laptop computers, that incorporate imaging devices (semiconductor devices), such as CCD image sensors or CMOS image sensors, are now widely used. Such type of an imaging device includes a camera module. The camera module includes a lens unit fixed on a substrate on which an image sensor is mounted. The lens unit includes a lens and a holder, which holds the lens.

When manufacturing the camera module, an adhesive agent is applied to the substrate at a predetermined location that includes the image sensor, and the lens unit is pressed against the substrate with the adhesive agent arranged in between. Then, the adhesive agent is hardened. This joins the lens unit and the substrate. An alignment mark is used to align the lens unit with the substrate. Japanese Laid-Open Patent Publication No. 2012-27063 describes aligning the lens unit with the substrate by using an alignment mark, which is provided as a reference on the lens unit, so that the optical axis of the lens coincides with the center of a light receiving surface in the image sensor.

### SUMMARY

The lens unit includes a number of components. Manufacturing errors may result in external dimension variations between each component. The variations may deviate the optical axis of the lens from the designed value relative to the alignment mark of the lens unit. In such a case, the optical axis of the lens would not coincide with the center of the light receiving surface of the image sensor even when the alignment mark is used as a reference for alignment. Such deviation of the optical axis leads to optical properties, such as resolution and brightness, becoming non-uniform in a peripheral portion of a captured image. This lowers the quality of the image.

According to one aspect of this disclosure, a method for manufacturing a camera module includes preparing a lens unit, which includes a lens and a diaphragm, preparing an image capturing unit including an image capturing element, detecting a center of a light receiving surface of the image capturing element, detecting a center of an opening of the diaphragm, aligning the lens unit and the image capturing unit so that the center of the opening of the diaphragm coincides with the center of the light receiving surface of the image capturing element, and joining the lens unit and the image capturing unit after the aligning the lens unit and the image capturing unit.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram illustrating one embodiment of an apparatus for manufacturing a camera module;

FIG. 2 is a schematic cross-sectional diagram illustrating the camera module; and

FIGS. 3 to 7 are schematic diagrams illustrating manufacturing steps of the camera module.

### DESCRIPTION OF THE EMBODIMENTS

One embodiment will now be described with reference to the accompanying drawings. Elements in the drawings are illustrated for simplicity and clarity and have not necessarily been drawn to scale. In the cross-sectional drawings, components may be illustrated without hatching lines.

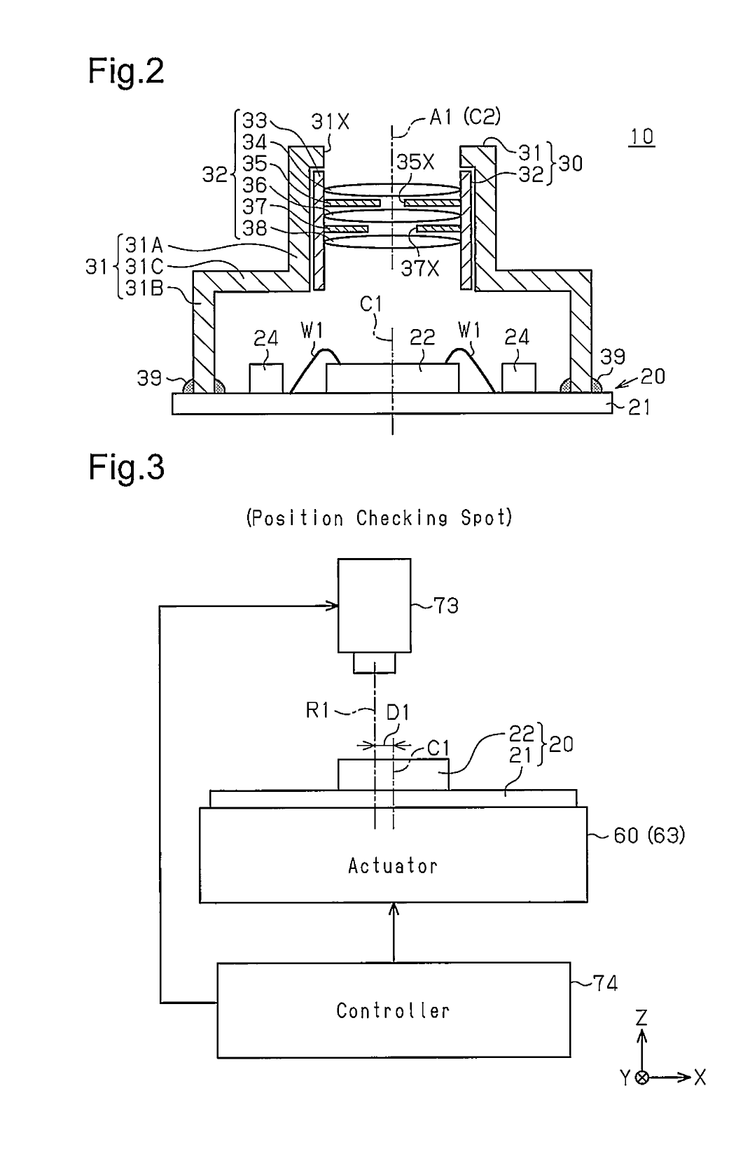

The overall structure of a camera module 10 will now be described. As illustrated in FIG. 2, the camera module 10 includes an image capturing unit 20 and a lens unit 30. The lens unit 30 is joined with the image capturing unit 20.

The image capturing unit 20 includes a substrate 21. An image capturing element 22 is mounted on an upper surface of the substrate 21. For example, a semiconductor element, such as a charge coupled device (CCD) image sensor or a complementary metal oxide semiconductor (CMOS) image sensor, may be used as the image capturing element 22. The image capturing element 22 is electrically connected by a conductive wire W1 to a wiring layer (not illustrated) formed on the substrate 21.

Also, a passive element 24 is mounted on the upper surface of the substrate 21. For example, a chip capacitor, a chip inductor, and/or a chip resistance may be used as the passive element 24.

The lens unit 30 is fixed to the upper surface of the substrate 21. The lens unit 30 includes, for example, an autofocus mechanism. The lens unit 30 includes a housing 31, a lens group 32, and a driver (not illustrated). The driver finely moves the lens group 32 in the direction of an optical axis A1 (vertical direction in FIG. 2) so that lenses in the lens group 32 are positioned in accordance with a focal point. The driver includes a driving source, such as a piezoelectric element or an electric motor. Various known mechanisms may be used as the autofocus mechanism of the camera module 10. Further, the present invention is not only applicable to a camera module including an autofocus mechanism but also applicable to a fixed-focused camera module.

The housing 31 is cylindrical and includes a first end surface (here, upper surface), which defines an opening 31X, and a second end surface, which is an open end. The first end surface of the housing 31 is a light incidence side (object side). The housing 31 includes a small diameter portion 31A, a large diameter portion 31B, and a shoulder portion 31C located between the small diameter portion 31A and the large diameter portion 31B. The large diameter portion 31B includes a lower end, which is fixed to the upper surface of the substrate 21. For example, the lower end of the large diameter portion 31B is joined with a peripheral edge of the upper surface of the substrate 21 by an adhesive agent 39. Thus, the image capturing element 22 is accommodated in an internal space defined between the housing 31 and the substrate 21.

The lens group 32 includes a holder 33, which is located above the image capturing element 22, lenses 34, 36, and 38, which are held in the holder 33, a diaphragm 35, and a light shield 37. The holder 33 is supported by, for example, the small diameter portion 31A of the housing 31, and is movable in the direction of the optical axis A1. The holder 33 is, for example, cylindrical.

The lens 34, the diaphragm 35, the lens 36, the light shield 37, and the lens 38, which are located in the holder 33 and aligned in the direction of the optical axis A1, are located at an upper position opposing the image capturing element 22. The lens 34 is located at the object side (light incidence side) of the diaphragm 35. The lenses 36 and 38 are located at an image side of the diaphragm 35. The lenses 34, 36, and 38 are arranged to have coinciding optical axes A1. Also, the optical axes A1 of the lenses 34, 36, and 38 substantially coincide with the center of the opening 31X of the housing 31. Further, in the camera module 10, the lens unit 30 is fixed to the substrate 21 so that the optical axes A1 of the lenses 34, 36, and 38 are orthogonal to a light receiving surface of the image capturing element 22 at the center C1 of the light receiving surface. That is, the lenses 34, 36, and 38 are arranged so that their optical axes A1 substantially coincide with the center C1 of the light receiving surface of the image capturing element 22. The lenses 34, 36, 38 form an optical image of an object on the light receiving surface of the image capturing element 22.

The diaphragm 35 adjusts the amount of light that has passed through the lens 34. For example, the diaphragm 35 includes an opening 35X. Based on an f-number corresponding to an open diameter of the opening 35X, the diaphragm 35 adjusts the amount of light that passes through the lens 34 and strikes the image capturing element 22. The diaphragm 35 is arranged so that the center C2 of the opening 35X coincides with the optical axes A1 of the lenses 34, 36, and 38. The diaphragm 35 may be formed so that the open diameter of the opening 35X is variable or fixed (invariable). The opening 35X may have any shape as viewed from above. For example, the opening 35X may be circular as viewed from above. The diaphragm 35 may be formed from, for example, a material that blocks the light passing through the lens 34.

The light shield 37 limits the occurrence of deficiencies, such as ghosts and flares caused by the reflection from a lens surface of the lens 38. The light shield 37 includes an opening 37X, which has a larger diameter than that of the opening 35X of the diaphragm 35. For example, the light shield 37 is arranged so that the center of the opening 37X coincides with the center C2 of the opening 35X of the diaphragm 35. However, the center of the opening 37X need not coincide with the center C2 of the opening 35X.

The lens unit 30 may include a cover glass at an upper position opposing the lens 34 (e.g., opening 31X of the housing 31) so that dust does not collect on the lens 34 and the like.

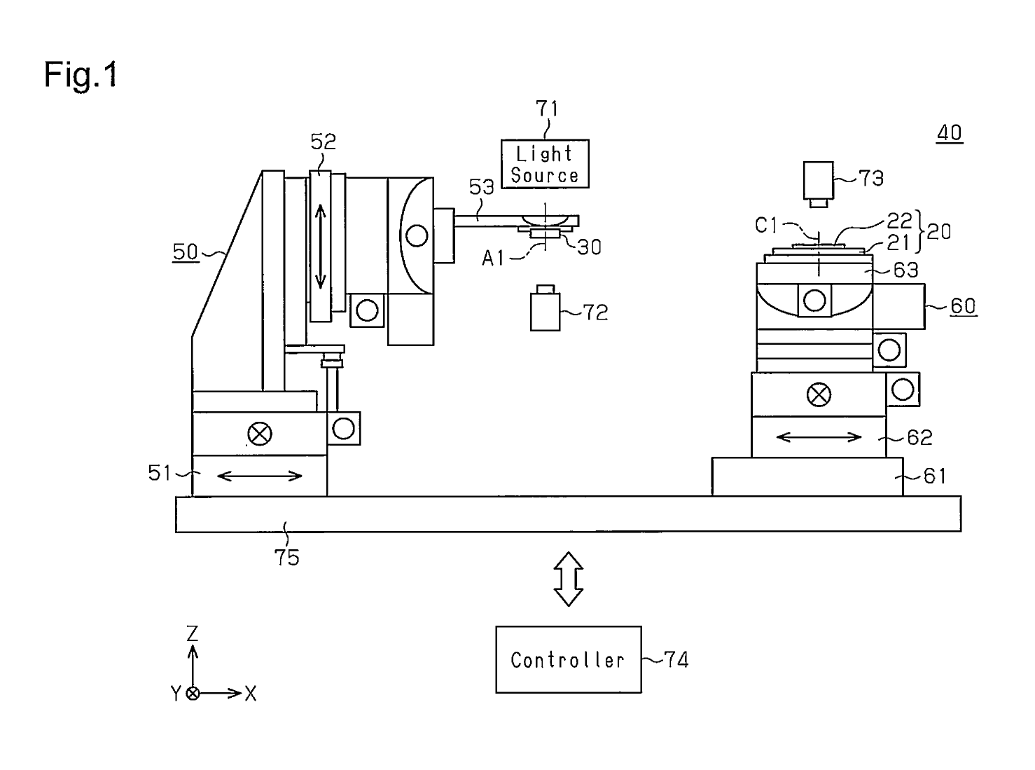

A manufacturing apparatus 40 that manufactures the camera module 10 will now be described with reference to FIG. 1.

As illustrated in FIG. 1, the manufacturing apparatus 40 includes an actuator 50 for the lens unit 30, an actuator 60 for the image capturing unit 20, a light source 71 that irradiates the lens unit 30 with light, and imaging devices 72 and 73. The manufacturing apparatus 40 also includes a controller 74. The controller 74 controls the actuators 50 and 60, the light source 71, and the imaging devices 72 and 73.

The actuator 50, which mechanically supports the lens unit 30, functions to move and rotate the lens unit 30 in a number of directions. The actuator 60, which mechanically supports the image capturing unit 20, functions to move and rotate the image capturing unit 20 in a number of directions. For example, the actuators 50 and 60 are capable of controlling six directions, namely, a Z-axis direction that is parallel to the optical axes A1 of the lenses 34, 36, and 38, X-axis and Y-axis directions that are orthogonal to each other in a plane orthogonal to the optical axis A1, and three rotational directions the centers of which are the Z-axis, the X-axis, and the Y-axis.

The actuator 50 includes a base 51 arranged on a rail 75. The rail 75 is fixed in and extends along a plane parallel to the X-axis and Y-axis directions. The base 51 is coupled to a position adjustment mechanism 52, which is capable of adjusting the position of the lens unit 30 in the above six directions. The position adjustment mechanism 52 is mechanically coupled to a holding portion 53, which holds the lens unit 30 in a removable manner.

The actuator 50 is movable on the rail 75. For example, the base 51 is movable along the rail 75. The base 51 may move along the rail 75 so that the actuator 50 moves back and forth between a station at which the position of the lens unit 30 is checked (“position checking spot”) and a station at which the lens unit 30 and the image capturing unit 20 are assembled (“assembly spot”).

The actuator 60 includes a base 61 arranged on a rail 75. The base 61 is coupled to a position adjustment mechanism 62, which is capable of adjusting the position of the image capturing unit 20 in the above six directions. The position adjustment mechanism 62 is mechanically coupled to a holding portion 63, which holds the image capturing unit 20 in a removable manner.

The actuator 60 is movable on the rail 75. For example, the base 61 is movable along the rail 75. The base 61 may move along the rail 75 to move the actuator 60 back and forth between a station at which the position of the image capturing unit 20 is checked (“position checking spot”) and the “assembly spot”.

The light source 71 and the imaging device 72 are located in the position checking spot where the position of the lens unit 30 is determined. The light source 71 and the imaging device 72 are fixed at, for example, given locations in the position checking spot. For example, the light source 71 is located above the lens unit 30, which is held by the holding portion 53, so that the light source 71 can irradiate the lens unit 30 with light from above. For example, the imaging device 72 is located below the lens unit 30, which is held by the holding portion 53, so that the imaging device 72 can receive the light that passes through the opening 35X of the diaphragm 35 of the lens unit 30 (refer to FIG. 2). The imaging device 72 captures an image of the lens unit 30 (lens group 32), which is irradiated with the light from the light source 71, from below and outputs image data to the controller 74. The holding portion 53 of the actuator 50 is formed from a material that is optically transparent in the wavelength band used by the light source 71. The diaphragm 35 is formed from a material that blocks the light in the wavelength band used by the light source 71. That is, the light source 71 emits light in a wavelength band that allows the light to be transmitted through the holding portion 53 and only the opening 35X of the diaphragm 35 while being blocked by the diaphragm 35. For example, a CCD camera may be used as the imaging device 72.

The imaging device 73 is located in the position checking spot where the position of the image capturing unit 20 is checked. For example, the imaging device 73 is located above the image capturing unit 20, which is held by the holding portion 63, so that the imaging device 73 may capture an image the entire light receiving surface of the image capturing element 22 in the image capturing unit 20. The imaging device 73 captures an image of the image capturing unit 20 (light receiving surface of the image capturing element 22) from above and outputs image data to the controller 74. For example, a CCD camera may be used as the imaging device 73.

The controller 74 cooperates with the actuators 50 and 60, the light source 71, and the imaging devices 72 and 73 to control processes performed to assemble the image capturing unit 20 and the lens unit 30 and various accompanying processes. For example, the controller 74 controls a process for coinciding the optical axes A1 of the lenses 34, 36, and 38 with the center C1 of the light receiving surface in the image capturing element 22. The controller 74 has an image processing function to process the image data received from the imaging devices 72 and 73. For example, a personal computer including a central processing unit, a ROM, which stores various data and control programs, and a RAM, which stores various working data, may be used as the controller 74. Further, for example, the personal computer includes an input device, such as a keyboard and a mouse, an output device such as a display, and a memory medium (memory unit) such as a hard disk drive (HDD).

A method for manufacturing the camera module 10 will now be described with reference to FIGS. 3 to 7. For simplicity and clarity, FIGS. 3 to 7 illustrate only some of the elements illustrated in FIGS. 1 and 2. Further, the description will center on the position adjustment (location adjustment) of the lens unit 30 and the image capturing unit 20 relative to the X-axis direction performed by the position adjustment mechanisms 52 and 62 of the actuators 50 and 60.

FIG. 3 schematically illustrates a process for checking the position of the image capturing unit 20. As illustrated in FIG. 3, under the control of the controller 74, the actuator 60 moves to the “position checking spot” and holds the image capturing unit 20 at that spot.

As illustrated in FIG. 3, the image capturing unit 20 is set on the holding portion 63 of the actuator 60. For example, by using an attachment mechanism (not illustrated), the image capturing unit 20 is attached to the holding portion 63. In this manner, the holding portion 63 holds the image capturing unit 20 having the image capturing element 22 mounted on the substrate 21.

In accordance with the control of the controller 74, the imaging device 73 captures an image of the image capturing unit 20 (entire light receiving surface of image capturing element 22), which is held by the holding portion 63, from above and outputs image data to the controller 74. The controller 74 performs image processing on the image data to detect (measure) the center C1 of the light receiving surface of the image capturing element 22 and a reference position R1 of the actuator 60 (holding portion 63). The controller 74 calculates a deviation amount D1 of the center C1 and the reference position R1. In the present example, the deviation amount D1 in a plane parallel to the X and Y-axis directions is calculated.

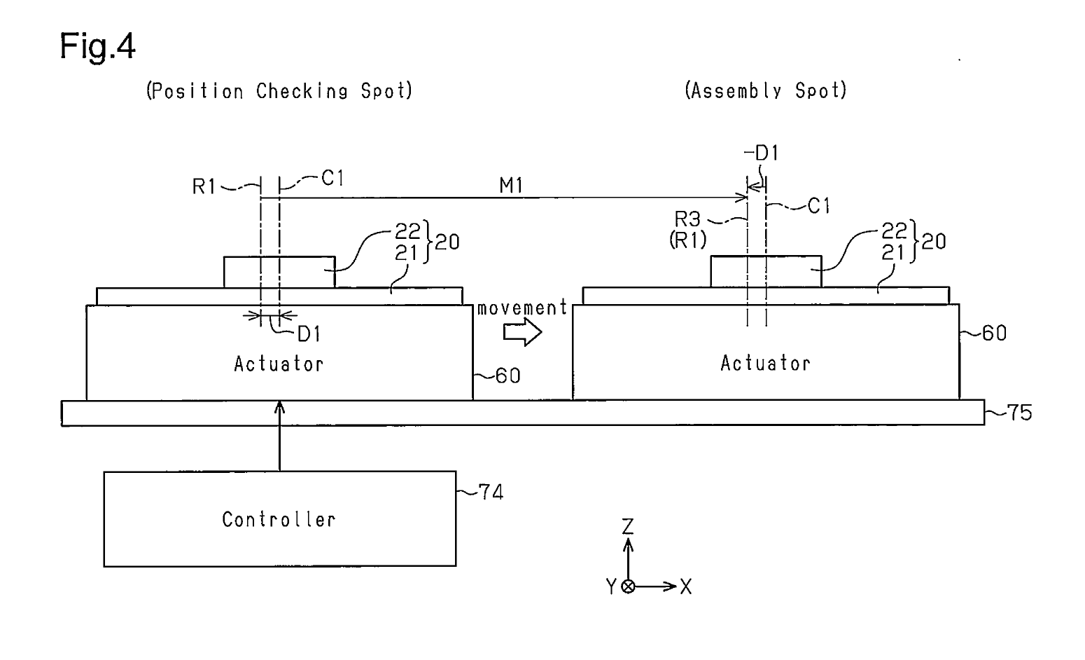

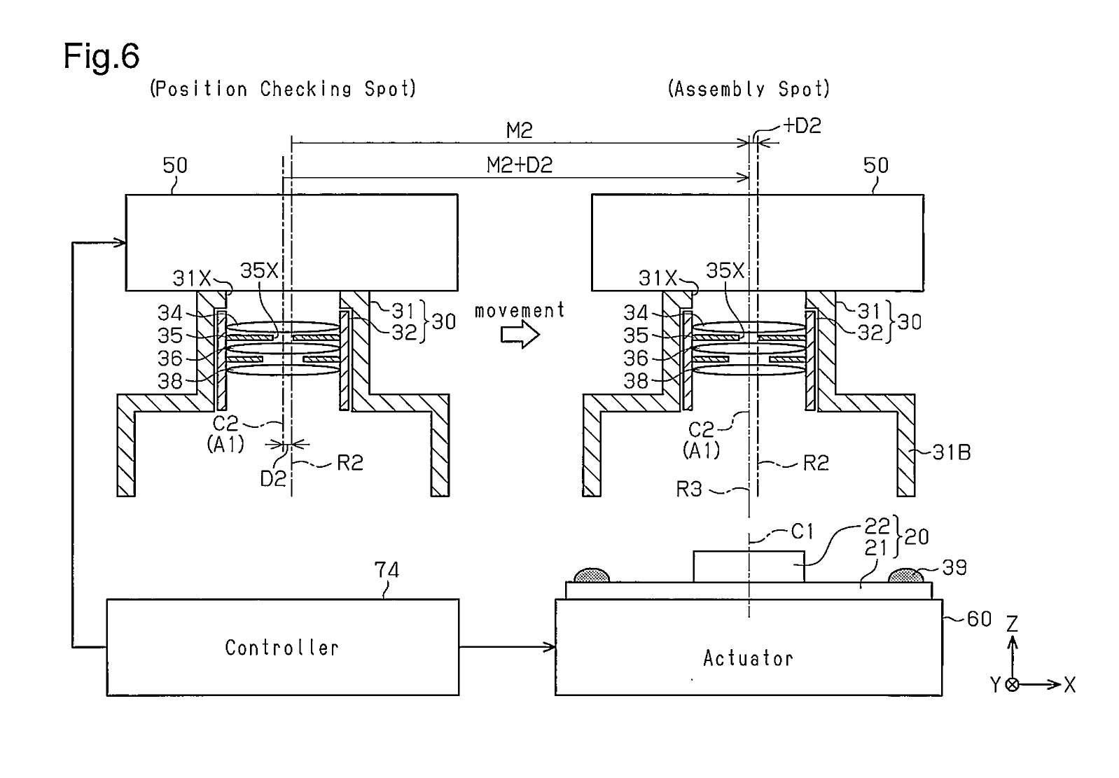

As illustrated in FIG. 4, the controller 74 drives the actuator 60 to move the actuator 60 and the image capturing unit 20, which is held by the actuator 60, from the “position checking spot” to the “assembly spot”. In this case, the controller 74 adjusts the position of the image capturing unit 20 to offset the deviation amount D1. For example, when the actuator 60 is moved along the rail 75 by a moving amount M1 from the “position checking spot” to the “assembly spot”, the reference position R1 of the actuator 60 for the “position checking spot” is aligned with a reference position R3 that is set in the “assembly spot”. Then, the controller 74 drives the actuator 60 to correct the position of the image capturing unit 20 so that the deviation amount D1 is offset, that is, the center C1 of the light receiving surface of the image capturing element 22 coincides with the reference position R3. For example, based on the deviation amount D1, the controller 74 calculates a correction moving amount (here, correction moving amount in the X-axis direction) of the image capturing unit 20 that is needed for the center C1 of the light receiving surface and the reference position R3 to coincide. In the present example, when the deviation amount D1 is calculated, the center C1 of the light receiving surface is located at the side of the reference position R1 closer to the “assembly spot”. Therefore, the correction moving amount of the image capturing unit 20 is calculated as −D1. The minus sign “−” indicates movement of the image capturing unit 20 in the direction from the “assembly spot” to the “position checking spot”. The controller 74 corrects the position of the image capturing unit 20 by driving the position adjustment mechanism 62 (refer to FIG. 1) of the actuator 60 based on the correction moving amount −D1. As illustrated in FIG. 6, this allows the center C1 of the light receiving surface to coincide with the reference position R3.

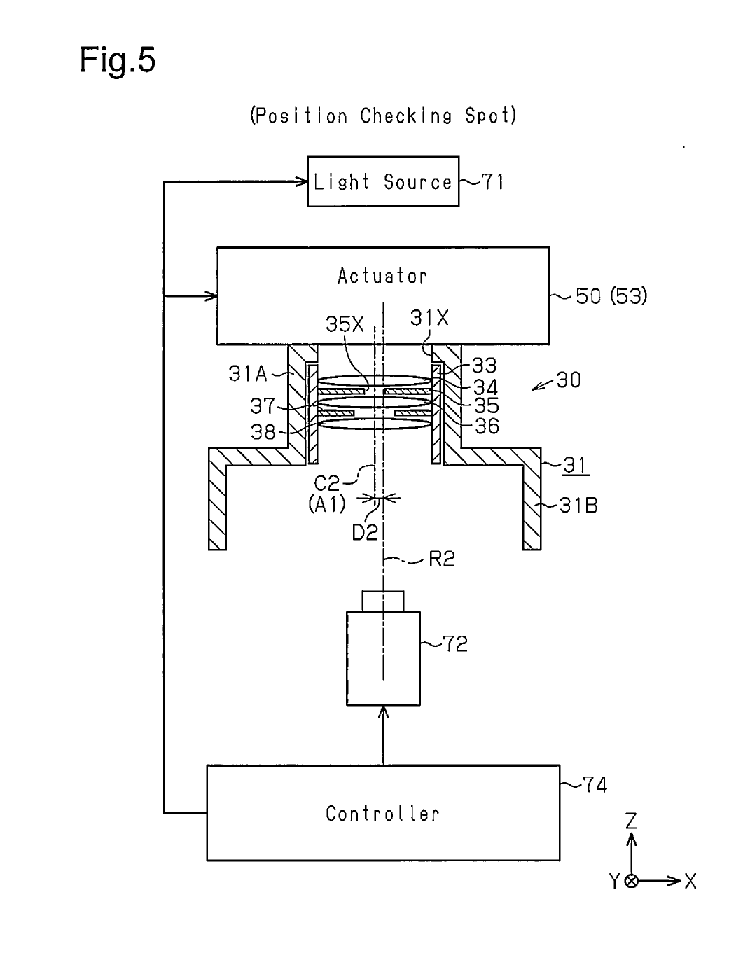

FIG. 5 schematically illustrates a process for checking the position of the lens unit 30. As illustrated in FIG. 5, under the control of the controller 74, the actuator 50 moves to the “position checking spot” and holds the lens unit 30 at this spot.

As illustrated in FIG. 5, the lens unit 30 is set on the holding portion 53 of the actuator 50. For example, by using an attachment mechanism (not illustrated), the lens unit 30 is attached to the holding portion 53. In this manner, the holding portion 53 holds the lens unit 30 in which the housing 31 supports the holder 33, which holds the lenses 34, 36, and 38, the diaphragm 35, and the light shield 37. In this case, the lenses 34, 36, and 38 and the diaphragm 35 are held by the holder 33 so that the optical axes A1 of the lenses 34, 36, and 38 coincide with one another and so that the optical axes A1 coincide with the center C2 of the opening 35X of the diaphragm 35.

Under the control of the controller 74, the lens unit 30 is irradiated with the light from the light source 71, which is located above the holding portion 53 and the lens unit 30. Under the control of the controller 74, the imaging device 72 captures an image of the lens unit 30 from below and sends image data to the controller 74. In this case, the light emitted from the light source 71 is converged by the lens 34 and received by the light receiving surface of the imaging device 72 through the opening 35X of the diaphragm 35 and the lenses 36 and 38. Thus, the imaging device 72 captures an image of the opening 35X in the diaphragm 35. Further, the imaging device 72 captures an image of the exit pupil, which is an image of an object formed by the lens 36 located at the image side (here, lower side) of the diaphragm 35.

The controller 74 performs image processing on the image data received from the imaging device 72 to detect (measure) the center C2 of the opening 35X of the diaphragm 35 and a reference position R2 of the actuator 50 (holding portion 53). As described above, the diaphragm 35 is arranged so that the center C2 of the opening 35X coincides with the optical axis A1. Therefore, detection of the center C2 of the opening 35X in the diaphragm 35 allows for detection of the position of the optical axis A1 or a position that is extremely close to the optical axis A1. Further, the controller 74 calculates a deviation amount D2 of the center C2 of the opening 35X, which substantially coincides with the optical axis A1, from the reference position R2. The present example calculates the deviation amount D2 in the plane parallel to the X and Y-axis directions.

As illustrated in FIG. 6, the controller 74 drives the actuator 50 to move the actuator 50 and the lens unit 30, which is held by the actuator 50, from the “position checking spot” to the “assembly spot”. In this case, the controller 74 adjusts the position of the lens unit 30 to offset the deviation amount D2. For example, when the actuator 50 is moved along the rail 75 (refer to FIG. 1) by a moving amount M2 from the “position checking spot” to the “assembly spot”, the reference position R2 of the actuator 50 for the “position checking spot” is aligned with the reference position R3 that is set in the “assembly spot”. The controller 74 drives the actuator 50 to correct the position of the lens unit 30 so that the deviation amount D2 is offset, that is, the center C2 (optical axis A1) of the opening 35X of the diaphragm 35 coincides with the reference position R3. For example, based on the deviation amount D2, the controller 74 calculates a correction moving amount (here, correction moving amount in the X-axis direction) of the lens unit 30 that is needed for the center C2 of the opening 35X to coincide with the reference position R3. In the present example, when the deviation amount D2 is calculated, the center C2 of the opening 35X is located at the side of the reference position R2 farther from the “assembly spot”. Therefore, the correction moving amount of the lens unit 30 is calculated as +D2. The plus sign “+” indicates the movement of the lens unit 30 in the direction from the “position checking spot” to the “assembly spot”. The controller 74 corrects the position of the lens unit 30 by driving the position adjustment mechanism 52 (refer to FIG. 1) of the actuator 50 based on the correction moving amount +D2. As illustrated in FIG. 6, this allows the center C2 of the opening 35X to coincide with the reference position R3. Through the process illustrated in FIG. 4, the center C1 of the light receiving surface is aligned with the reference position R3. Thus, after the process illustrated in FIG. 6, the center C2 of the opening 35X and the center C1 of the light receiving surface of the image capturing element 22 coincide with the reference position R3. Consequently, the optical axis A1 and the center C1 of the light receiving surface may substantially coincide with the reference position R3.

As illustrated in FIG. 6, the adhesive agent 39 is applied to a given location on the upper surface of the substrate 21 using a dispenser or the like (not illustrated). The location where the adhesive agent 39 is applied corresponds to the shape of the lower end of the large diameter portion 31B of the housing 31.

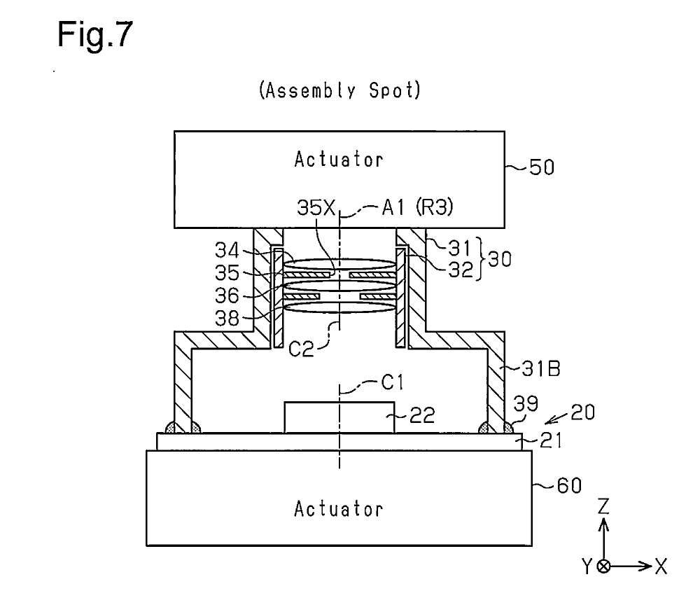

As illustrated in FIG. 7, when the optical axis A1 is aligned with the center C1 of the light receiving surface, the lens unit 30 is joined with the image capturing unit 20. For example, the controller 74 drives the actuator 50 to move the lens unit 30 in the Z-axis direction (here, lower direction) toward the image capturing unit 20, which is held by the actuator 60. Then, by pressing the lower end of the large diameter portion 31B of the housing 31 against the application location of the adhesive agent 39, the housing 31 is temporarily attached to the substrate 21. When the adhesive agent 39 is hardened, the housing 31 is fixed to the substrate 21. This manufactures the camera module 10 in which the center C1 of the light receiving surface of the image capturing element 22 coincides with the center C2 of the opening 35X of the diaphragm 35, which substantially coincides with the optical axis A1.

The present embodiment has the advantages described below.

(1) After the center C1 of the light receiving surface in the image capturing element 22 and the center C2 of the opening 35X in the diaphragm 35 are detected, the image capturing unit 20 and the lens unit 30 are aligned so that the centers C1 and C2 coincide. This allows the centers C1 and C2 to accurately coincide with each other. The diaphragm 35 is arranged so that the center C2 of the opening 35X substantially coincides with the optical axis A1. The accurate coincidence of the centers C1 and C2 allows the optical axis A1 to substantially coincide with the center C1. In this manufacturing method, the deviation amount between the center C2 and the optical axis A1 resulting from manufacturing errors or the like is significantly smaller than the deviation amount between an alignment mark and the optical axis of a lens in the prior art. This drastically reduces the deviation amount between the optical axis A1 and the center C1 compared with the deviation amount between the optical axis of the lens and the center of a light receiving surface in the prior art (for example, to half or less). As a result, deterioration of the image quality of the camera module 10 can be suppressed.

(2) The lens unit 30 is imaged when irradiated with the light emitted from the light source 71. The center C2 of the opening 35X in the diaphragm 35 is detected from the captured image. This method allows the imaging device 72 to accurately capture the image of the opening 35X of the diaphragm 35. Thus, the center C2 of the opening 35X of the diaphragm 35 may be accurately detected based on the image captured by the imaging device 72.

It should be apparent to those skilled in the art that the present invention may be embodied in many other specific forms without departing from the scope of the invention. Particularly, it should be understood that the present invention may be embodied in the following forms.

In the above embodiment, the position checking process of the lens unit 30 is performed after the position checking process of the image capturing unit 20. Instead, for example, the position checking process of the image capturing unit 20 may be performed after the position checking process of the lens unit 30. Alternatively, the position checking processes of the image capturing unit 20 and the lens unit 30 may be simultaneously performed.

The camera module 10 of the above embodiment is not limited to a particular structure. For example, the holder 33 may hold any number of lenses. Also, the housing 31 and the holder 33 may have any shape. Any type or number of elements may be mounted on the substrate 21. The image capturing unit 20 and the lens unit 30 may be joined at any location.

The manufacturing apparatus 40 of the above embodiment is not particularly limited to the structure illustrated in FIG. 1. The manufacturing apparatus may have any structure as long as the image capturing unit 20 and the lens unit 30 can be separately held, at least one of the image capturing unit 20 and the lens unit 30 is movable in the Z, X, and Y-axis directions, and the imaging devices 72 and 73 are included. Modified examples of the structure of the manufacturing apparatus 40 will now be described.

In the above embodiment, the position adjustment mechanisms 52 and 62 are capable of controlling the locations (positions) of the lens unit 30 and the image capturing unit 20 in six directions. However, the number of controllable directions may be five or less or seven or more. For example, each of the actuators 50 and 60 may be modified to be movable in three directions, which are the Z, X, and Y-axis directions.

In the above embodiment, the position adjustment mechanism 62 of the actuator 60 may be omitted. In this case, the actuator 50 and the position adjustment mechanism 52 may adjust the position of the lens unit 30 to offset not only the deviation amount D2 but also the deviation amount D1 so that the lens unit 30 is aligned with the image capturing unit 20.

In the above embodiment, the position adjustment mechanism 52 of the actuator 50 may be omitted. In this case, the actuator 60 and the position adjustment mechanism 62 may adjust the position of the image capturing unit 20 to offset not only the deviation amount D1 but also the deviation amount D2 so that the image capturing unit 20 is aligned with the lens unit 30.

In the above embodiment, the actuator 60 of the image capturing unit 20 is movable along the rail 75. However, the actuator 60 may be fixed to the “assembly spot”. In this case, the imaging device 73 may be located in the “assembly spot” to capture the image of the image capturing unit 20. Instead of the deviation amount between the center C1 of the light receiving surface of the image capturing element 22 and the reference position R1 of the actuator 60, a deviation amount between the center C1 of the light receiving surface and the reference position R3 at the “assembly spot” may be detected based on the image data obtained by the imaging device 73. In this case, the position adjustment mechanism 62 of the actuator 60 adjusts the position of the image capturing unit 20 to offset the deviation amount between the center C1 and the reference position R3. Alternatively, the actuator 50, which offsets the deviation amount D2, may adjust the position of the lens unit 30 to offset the deviation amount between the center C1 and the reference position R3 so that the lens unit 30 is aligned with the image capturing unit 20.

In the above embodiment, the deviation amounts D1 and D2 are offset by adjusting the moving amounts of the actuators 50 and 60 on the rail 75 and the moving amount of the position adjustment mechanisms 52 and 62. In this manner, the lens unit 30 is aligned with the image capturing unit 20. Instead, for example, the deviation amounts D1 and D2 may be offset only by adjusting at least one of the moving amounts of the actuators 50 and 60 on the rail 75 so that the lens unit 30 is aligned with the image capturing unit 20.

In the above embodiment, at the position checking spot (refer to FIG. 5) where the position of the lens unit 30 is checked, the light source 71 is located above the lens unit 30, and the imaging device 72 is located below the lens unit 30. Instead, for example, the light source 71 may be located below the lens unit 30, and the imaging device 72 may be located above the lens unit 30.

In the above embodiment, the light source 71 may be omitted. For example, when the imaging device 72 can capture the image of the opening 35X in the diaphragm 35 using only ambient light, the light source 71 may be omitted.

Clauses

This disclosure further encompasses various embodiments described below.

1. An apparatus for manufacturing a camera module, the apparatus including:
a first actuator including a first holding portion, wherein the first holding portion is capable of holding an image capturing unit including an image capturing element and is movable toward a given position;
a first imaging device configured to capture an image of the image capturing unit held by the first holding portion;
a second actuator including a second holding portion, wherein the second holding portion is capable of holding a lens unit including a lens and a diaphragm and is movable toward the given position;
a second imaging device configured to capture an image of the lens unit held by the second holding portion; and
a controller configured to control the first and second actuators and the first and second imaging devices, wherein the controller is configured to
   detect a center of a light receiving surface of the image capturing element based on the image captured by the first imaging device,
   detect a center of an opening of the diaphragm based on the image captured by the second imaging device,
   align the lens unit and the image capturing unit by moving at least one of the first and second holding portions so that the center of the opening of the diaphragm coincides with the center of the light receiving surface of the image capturing element, and
   move the first and second actuators toward each other to join the lens unit and the image capturing unit.

The present examples and embodiments are to be considered as illustrative and not restrictive, and the invention is not to be limited to the details given herein, but may be modified within the scope and equivalence of the appended claims.

1. A method for manufacturing a camera module, the method comprising:
preparing a lens unit, wherein the lens unit includes a lens and a diaphragm;
preparing an image capturing unit including an image capturing element;
detecting a center of a light receiving surface of the image capturing element;
detecting a center of an opening of the diaphragm;
aligning the lens unit and the image capturing unit so that the center of the opening of the diaphragm coincides with the center of the light receiving surface of the image capturing element; and
joining the lens unit and the image capturing unit after the aligning the lens unit and the image capturing unit.

2. The method according to claim 1, wherein the detecting a center of an opening of the diaphragm includes
capturing an image of the lens unit, which is irradiated with light from a light source, with a first imaging device, and
detecting the center of the opening of the diaphragm from the image captured by the first imaging device.

3. The method according to claim 2, wherein
the first imaging device is arranged at an image side of the lens unit where the image capturing element is located, and
the light source is arranged at an object side of the lens unit that is opposite to the image side.

4. The method according to claim 1, wherein the detecting a center of a light receiving surface of the image capturing element includes
capturing an image of the image capturing unit with a second imaging device, and
detecting the center of the light receiving surface of the image capturing element from the image captured by the second imaging device.

5. The method according to claim 1, further comprising:
holding the image capturing unit with a first holding portion, wherein the first holding portion is movable toward a given position;
calculating a first deviation amount of the center of the light receiving surface of the image capturing element from a reference position of the first holding portion or the given position;
holding the lens unit with a second holding portion, wherein the second holding portion is movable toward the given position; and
calculating a second deviation amount of the center of the opening of the diaphragm from a reference position of the second holding portion,
wherein the aligning the lens unit and the image capturing unit includes moving at least one of the lens unit and the image capturing unit to offset the first deviation amount and the second deviation amount so that the lens unit and the image capturing unit are aligned.

6. The method according to claim 1, further comprising:
calculating a first deviation amount of the center of the light receiving surface of the image capturing unit from a first reference position; and
calculating a second deviation amount of the center of the opening of the diaphragm from a second reference position,
wherein the aligning the lens unit and the image capturing unit includes
correcting a position of the image capturing unit to offset the first deviation amount, and
correcting a position of the lens unit to offset the second deviation amount.

7. The method according to claim 6, further comprising:
moving the image capturing unit to a third reference position after calculating the first deviation amount; and
moving the lens unit to the third reference position after calculating the second deviation amount, wherein
the correcting a position of the image capturing unit includes moving the image capturing unit from the third reference position based on the first deviation amount, and
the correcting a position of the lens unit includes moving the lens unit from the third reference position based on the second deviation amount.
